(19) United States
(12) Patent Application Publication
(10) Pub. No.: US 2025/0377064 A1
(43) Pub. Date: Dec. 11, 2025

(54) WATER-PIPE REPAIR SYSTEM

(71) Applicant: Ramez Alkhoury, Santa Clara, CA (US)

(72) Inventor: Ramez Alkhoury, Santa Clara, CA (US)

(21) Appl. No.: 18/740,425

(22) Filed: Jun. 11, 2024

(51) Int. Cl. F16L 55/17; F16L 55/168

(52) U.S. Cl. CPC F16L 55/1715; F16L 55/1683

(57) ABSTRACT

The invention is a non-metallic pipe repair system that can surround and seal a damaged pipe without having to cut the pipe and/or move the pipe axially to install the pipe repair system.

### TECHNICAL FIELD

The invention is a system for repairing a damaged water pipe.

### BACKGROUND OF INVENTION

A small opening in the side of an installed water pipe can allow water to leak out and damage the surface of whatever is below it.

Ordinarily, the pipe section with the damage must be replaced which can be a time-consuming and costly repair.

A pipe may be cut above and below the damage point and a coupler acting as a bridge may be installed. Often this requires having to move one or both portions of the severed pipe in order to install the coupler.

### BRIEF DESCRIPTION OF INVENTION

The invention herein disclosed and claimed is a repair system for damaged pipes that can be installed without having to cut the damaged pipe, or to reposition the damaged pipe in order to install a coupler.

The system comprises a coupler that has two complementary, half-cylindrical, portions that are connected via a hinging fixture, and when positioned over the damaged portion, the halves then snap together forming a cylindrical seal over the damaged pipe.

Before installing the repair system, it is treated with adhesive sealant on both halves. After installation, and after the sealant has cured, the repair system will seal the damaged pipe and eliminate any further leakage.

### BRIEF DESCRIPTION OF DRAWINGS

FIG. 1 shows an edge-on view of the repair system when closed.

FIG. 2 shows an edge-on view of the repair system when open prior to installation.

FIG. 3 shows a side view of the repair system with the hinging fixture closest to the viewer.

FIG. 4 shows a side view of the repair system with the latching fixture closest to the viewer.

FIG. 5 shows the sequence of steps for installing the repair system.

### DETAILED DESCRIPTION OF INVENTION

Where a pipe through which water must flow develops a crack in its side allowing water under pressure to leak out, the leak will cause water to fall onto a surface below the pipe causing flooding and damage.

Ordinarily, one repairs a damaged pipe by either replacing it entirely, or cutting out a section that contains the leaking surface and installing a coupler bridging the two cut ends.

This repair method often requires moving one or both pipe sections axially away from the coupler, to allow it to be positioned, the moved axially in the opposite direction to insert each end securely into the coupler. This can be time consuming and expensive.

The repair system herein disclosed is designed to repair a damaged pipe using a system comprised of hinged, half-cylindrical structures, which after being positioned so as to encompass the pipe's damage location, can then be closed to form a latched, cylindrical covering tightly adhering to the damaged pipe and sealing the damaged spot.

Because the repair system comprises two half-cylindrical structures, it may be moved into position without requiring that the pipe be cut or moved axially. Instead, the open repair system is first prepared with adhesive sealant on its inside surfaces, then positioned, and finally closed so as to form a complete, latched cylinder that is firmly adhered to the damaged pipe and seals it against further leakage.

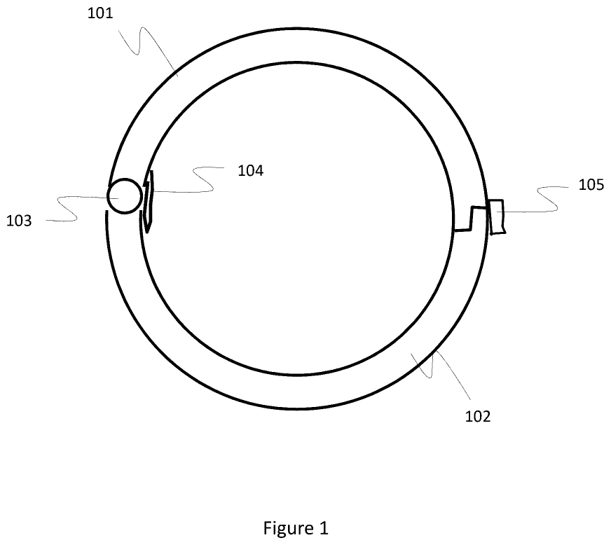

FIG. 1 shows an edge-on view of the repair system comprising cylinder halves (101 and 102), hinging fixture (103), sealing structure (104) and latching structure (105). As shown the halves are firmly closed and latched forming a full cylindrical sleeve.

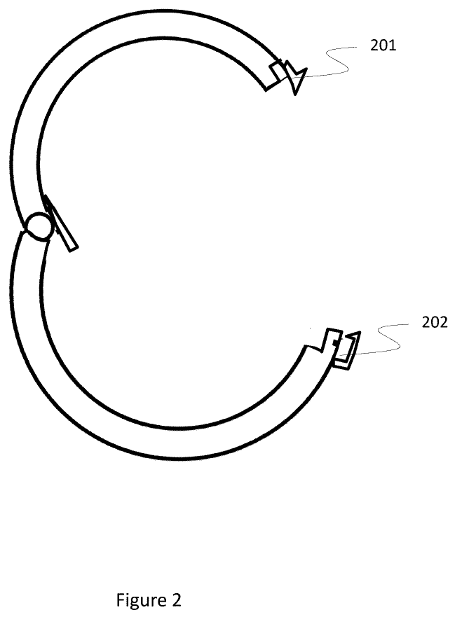

FIG. 2 shows the repair system, prior to installation, in open position and provides more detail about the hinging structure (FIG. 1, 105) showing its two portions (201 and 202). When the cylindrical halves are closed together, the portions 201 and 202 will latch together.

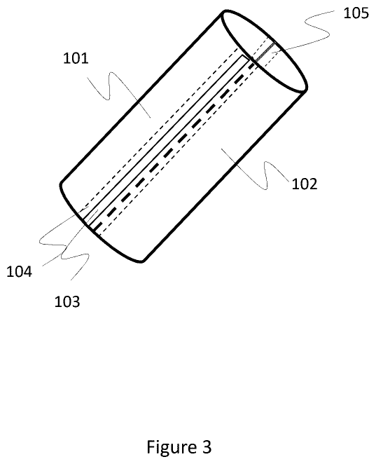

FIG. 3 is a side view further illustrating the hinging fixture portion of the repair system. In the near view, the hinging fixture (103) is covered by the sealing structure (104) when the halves are closed an latched. The latching structure (105) is shown in the far view.

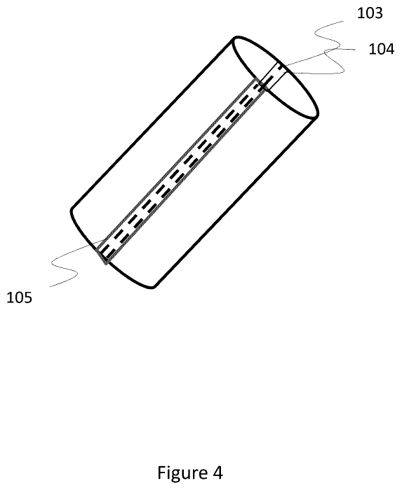

FIG. 4 is a side view further illustrating the latching fixture portion of the repair system. In the near view, the latching structure (105) is shown and depicted is the sealing function of the latching faces of the half-cylindrical portions. As such, when closed and latched, the half-cylindrical portions form a full cylindrical sleeve with sealing structures preventing leakage through the seams on either side.

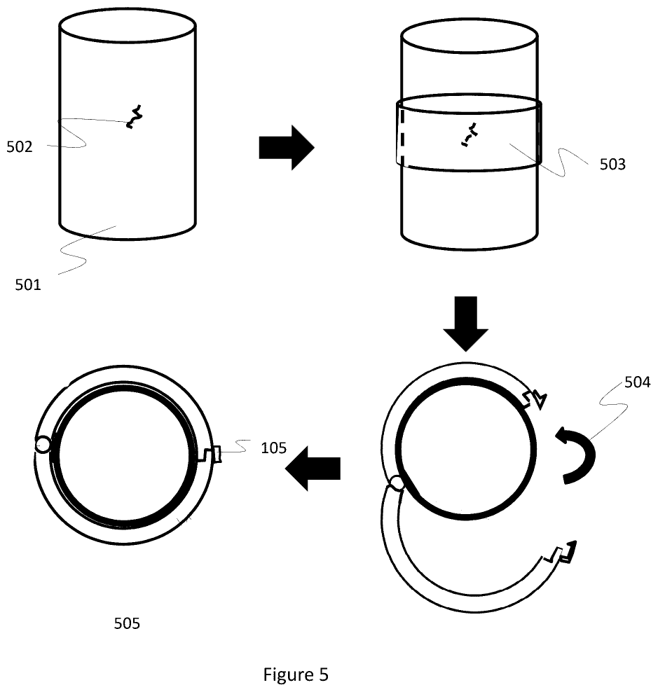

FIG. 5 shows an exemplary sequence of method steps for installing the pipe repair system. First, the damaged portion of the pipe (501) is located (502). Next, (not shown) an adhesive sealant is applied to the inside surfaces of the repair system, and then the open repair system is positioned (503) such that it will cover the damaged pipe location when closed and latched. Next, the two half-cylindrical halves, coated with adhesive sealant, are closed by snapping them together in the direction 504 until they are fully closed, and latching structure 105 is engaged. Once so installed, after the adhesive sealant has cured, the pipe may again be used with no further leakage.

All drawings and descriptions are meant to be exemplary and should not be read as limiting the scope of the invention. The repair system may be made of non-metallic or metallic materials The circumference of the inside surface of the closed, latched, repair system is essentially that of the outer circumference of the damaged pipe. This ensures a firm fit when installed.

What is claimed is:

1. A water pipe repair system comprising:
a first portion that is semi-cylindrical;
a second portion that is semi-cylindrical;
a hinging fixture on one axial edge of the first portion;
a mating hinging fixture on one axial edge of the second portion;
a latching fixture on opposite axial edge of the first portion;
a mating latching fixture on opposite axial edge of the second portion; and
a sealing structure on the same axial edge a the hinging fixture of the first portion.

2. A claim as in claim 1 wherein:
the first portion and the second portion are joined at respective axial edges by their respective hinging fixtures.

3. A claim as in claim 1 wherein:
the first portion and the second portion, when joined by the hinging fixture at their respective axial edges can rotate so as to form a complete cylindrical structure.

4. A claim as in claim 3 wherein:
when the first portion and the second portion are rotated so as to form the complete cylindrical structure, the latching fixture on the first portion, and the mating latching fixture on the second portion, will latch together to form a locked cylindrical structure.

5. A claim as in claim 3 wherein:
when the first portion and the second portion are rotated so as to form the complete cylindrical structure, the sealing structure of the first portion will be pressed against the hinging structure and the second portion such that it seals against leaks.

6. A method of use of a pipe repair system wherein the pipe repair system comprises the elements of claim 1 comprises:
locating a point of leakage on an installed pipe;
positioning an open pipe repair system such that it loosely surrounds a section of the installed pipe and covers the point of leakage;
applying adhesive sealant to the inside surfaces of the loosely surrounding pipe repair system;
rotating each portion of the pipe repair system, while keeping it in position covering the point of leakage, until each portion together form a complete, closed, cylinder tightly surrounding the point of leakage;
applying pressure to each portion until a latching fixture snaps into place keeping the closed cylinder portions locked together; and
allowing the adhesive sealant to cure before allowing water to flow through a repaired pipe.
